(19) United States
(12) Patent Application Publication
(10) Pub. No.: US 2004/0143480 A1
(43) Pub. Date: Jul. 22, 2004

(54) Method and apparatus for estimation of Six Sigma performance

(76) Inventors: Kevin Weiss, Boston, MA (US); Arthur Zentner, Candiac (CA); Kunter Akbay, Niskayuna, NY (US)

Correspondence Address: Brett N. Dorny, Esq., Mintz, Levin, Cohn, Ferris,, Glovsky and Popeo, P.C., One Financial Center, Boston, MA, 02111, US

(21) Appl. No.: 10/347,857

(22) Filed: Jan. 21, 2003

(51) Int. Cl. G06F 17/60

(52) U.S. Cl. 705/10

(57) ABSTRACT

A system is provided for modeling and simulating a Six Sigma implementation. The system uses a process in which individuals in a Six Sigma initiative are the entities of the processes. The activities in the model correspond to the steps in implementing a Six Sigma initiative. Data is collected and outputted for review of performance.

### BACKGROUND OF THE INVENTION

1. Field of the Invention

The invention relates to a system for simulating performance by implementing a Six Sigma initiative within an organization. More particularly, it relates to a method and system for determining & communicating performance based upon a specified level of support and training.

2. Discussion of Related Art

Six Sigma has been gaining popularity among major corporations. Motorola Semiconductors, General Electric, Texas Instruments, Allied Signal and Digital Corporation are just some examples of major organizations using Six Sigma methodologies. Six Sigma is a highly disciplined approach that helps organizations focus on developing and delivering near-perfect products and services. “Sigma” is a statistical term that measures how far a given process deviates from perfection. The common measurement index is defects-per-unit where a unit can be virtually anything—a component, a part of a jet engine, an administrative procedure, etc. The sigma value indicates how often defects are likely to occur. As sigma increases, the number of defects goes down. Six Sigma represents no more than 3.4 defects per million opportunities. As defects decrease, customer satisfaction goes up, along with improvement of other metrics such as cost and cycle time. The central idea behind Six Sigma is that if you can measure how many “defects” you have in a process, you can systematically figure out how to eliminate them and get as close to “zero defects” as possible.

Many organizations have begun implementing Six Sigma as a major initiative. Implementation consists primarily of training employees to perform certain roles within the Six Sigma initiative and providing on-going supervision by more experienced or more highly trained people. Within the Six Sigma initiative, there are four major roles—Black Belts, Green Belts, Master Black Belts and Champions. Each of these roles has different training and supervision regimes and different process activities. Each of the people involved with a Six Sigma initiative either supports or executes specific projects. Projects involve reviews of existing processes or newly developing processes to determine causes of defects and redesign of processes to eliminate defects.

Most organizations agree that implementing Six Sigma can reduce defects, improve customer satisfaction, reduce costs, improve profits, and lead to significant growth opportunities. Developments in Six Sigma initiatives have related to improved training and monitoring processes. Other developments have devised mechanisms and procedures for measuring defects and determining improvements in reaching the Six Sigma goals. However, noticeably lacking is any understanding or analysis of the implementation process itself and how to best optimize resources. Organizations have limited resources to devote to Six Sigma initiatives. There is very little guidance on how to best utilize those resources or how to estimate the resulting improvements from different expenditures. In particular, organizations need to know who to train, how many people to train, what roles to train them for, and how to time training for maximum returns on the investment. Furthermore, Champions need to be higher level executives who have many other time demands. Often organizations seek to implement the Six Sigma process without impinging on the executives' time. Of course, while this can be done, it has a cost in terms of the potential improvements. Existing systems, however, provide no mechanisms for determining what that cost might be. Therefore, a need exists for a system to analyze implementation scenarios for the Six Sigma initiative and estimate results from different implementation strategies.

After initial implementation, organizations have no mechanisms for analyzing performance of the implementation. While systems can track projects and improvements in the reviewed processes, no system exists for tracking performance of the individuals involved in Six Sigma processes. Furthermore, no mechanisms exist for determining how to increase performance by optimizing the implementation process. Therefore, a need exists for a system, which can be used to analyze performance of an existing implementation for determining possible improvements.

### SUMMARY OF THE INVENTION

The present invention substantially overcomes the deficiencies of the prior art by providing a system and method for simulating performance for implementation of a Six Sigma initiative. In particular, the system and method of the present invention treats individuals participating in the Six Sigma initiative to be entities within a process for simulation. The process is reflected in a model using simulation software. Each step in a Six Sigma initiative is represented as an activity in the simulation software. Parameters are set to represent the performance of the Six Sigma initiative based upon the resources provided for implementation. According to another aspect of the invention, each entity is assigned individual attributes which operate as parameters in the simulation. The individual attributes change over time to represent an organization's maturity in Six Sigma and increases in an individuals value with maturation. According to an embodiment of the invention, the entities are limited by the costs of training and utilizing various types of individuals in the Six Sigma initiative.

According to another aspect of the invention, the system is able to capture statistics regarding performance of the Six Sigma initiative. In particular, the system determines utilization for different types of individuals (i.e., entities) and the creation and completion of Six Sigma projects. By adjusting various parameters, the performance of implementation of the Six Sigma initiative can be compared under different conditions.

According to another aspect of the invention, the system is used to analyze deficiencies of a Six Sigma initiative. In an embodiment of the invention, the parameters as set based upon actual organizational performance. The system is run to generate and capture data regarding utilization and performance. The captured data provides information about deficiencies in the implementation of the Six Sigma initiative.

According to an aspect of the invention, the system demonstrates how resources (people) move through activities to support and execute Six Sigma projects, and become transformed into more knowledgeable resources to the organization. This transformation process demonstrates how investments in a certain level of support and training can generate increased knowledge management within the organization to generate project benefits. According to another aspect of the invention the ability of people involved in the Six Sigma initiative to scope, execute, and/or support Six Sigma projects can be optimized based on parameter setting decisions.

### BRIEF DESCRIPTION OF THE DRAWINGS

FIG. 1 is a block diagram of a system according to an embodiment of the present invention.

FIG. 2 is a flow diagram for activities of green belts within the system of FIG. 1.

FIG. 3 is a flow diagram for activities of black belts within the system of FIG. 1.

FIG. 4 is a flow diagram for activities of champions within the system of FIG. 1.

FIGS. 5A-5D are illustrative of output of a system according to an embodiment of the present invention.

### DETAILED DESCRIPTION

The present invention relates to a system for simulating performance of a Six Sigma initiative. An embodiment of the present invention consists of software to be executed on a personal computer. Alternatively, the present invention could be implemented on any other type of computing device, including a mainframe computer, server, PDA, or handheld computer. The present invention could be implemented on a stand-alone computer, or as part of a network. It could be implemented at a server within a network, which is accessible and operable from any computer that can connect, directly or indirectly, to the server or the network.

According to a preferred embodiment of the present invention, process simulation software, such as is commercially available from ProcessModel, is used to represent the Six Sigma initiatives. In process simulation software, entities pass through the process steps known as “activities” and are acted upon within these activities. At each activity, the entities are processed for specified periods of time. The processing times may be variable according to designated distributions. The success of the processing may also be variable. Inputs may be required from other related processes or outputs provided to other processes. Additionally, activities in the process can be repeated as part of the process flow. In a manufacturing process, the system typically has steps corresponding to different machines or tasks. The entities represent the products being manufactured. However, in an embodiment of the present invention, the process simulation software is utilized in a different manner. The “entities” are the people involved in the Six Sigma initiative and the steps are the activities in the Six Sigma initiative. The people are then processed according to the necessary Six Sigma activities (referred to as steps below). Parameters associated with the activities relate to the resources provided in the implementation of the Six Sigma initiative. Data is collected about the processing and used to analyze performance of the implementation.

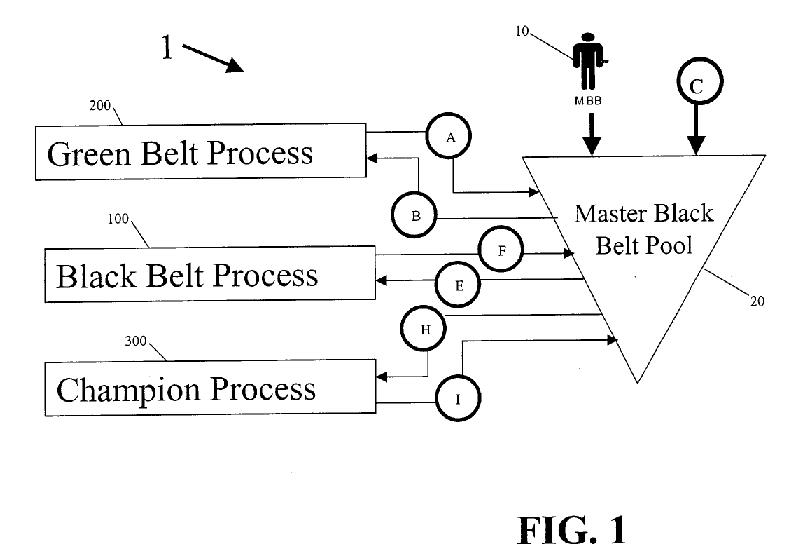

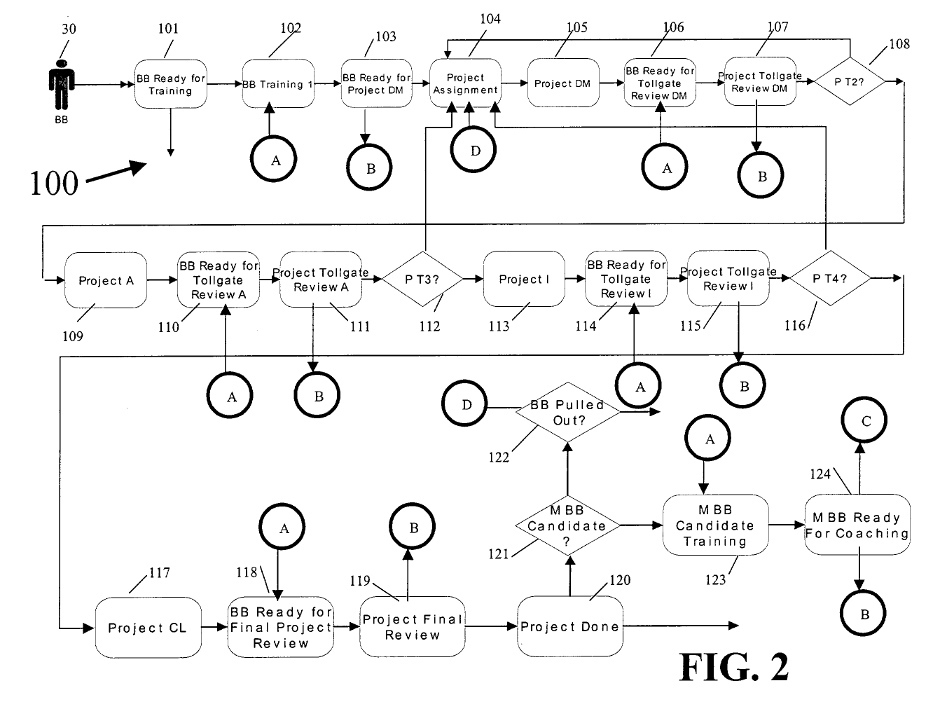

FIG. 1 illustrates the system 1 used in connection with the simulation software according to an embodiment of the present invention. As noted above, within a Six Sigma initiative, there are four principal roles for participants. The Master Black Belts 10 form a pool 20 of resources for supporting a Six Sigma initiative. Typically, when an organization begins implementation, the Master Black Belts are consultants or trainers from outside the organization. They provide the training for the other participants and provide help and guidance throughout the process. The Green Belts, Black Belts and Champions each have separate roles within the Six Sigma initiative. These roles are separately modeled as processes in the system 1 and are illustrated in FIGS. 2, 3 and 4. Each of these processes includes inputs and outputs from the Master Black Belt Pool. Thus, the Master Black Belt Pool 20 provides resources used in the other processes. Since people are the entities within the system of the present invention, when assistance of Master Black Belt 10 is needed in another process, a Master Black Belt 10 is removed from the pool 20 and returned once the assistance has been given. If no Master Black Belts 10 are available in the pool 20 when needed, the process may take a longer time to be completed or wait for a Master Black Belt 10 to become available. Master Black Belts 10 can also be created and added to the pool 20 within the system, as will be discussed below.

Black Belts 30 are the principal implementers of Six Sigma. The Black Belt process 100 is illustrated in FIG. 2. Black Belts 30 are the experts groomed within an organization to lead Six Sigma projects. Six Sigma projects are the procedures for reviewing and improving an organization's processes to reduce errors. Black Belts 30 require deep statistical abilities, as well as strong leadership and interpersonal skills. The people selected to become Black Belts 30 depends upon the size and resources of an organization. The first activity or step 101 in the Black Belt process 100 is to create a pool of people to be trained as Black Belts. Each step in the modeling process includes logic for operating on the “entities” in the process, in this case, the Black Belts. At step 101, a pool of Black Belts to be trained is created. Various parameters can be set within the system. One of the parameters is the total number of people who will become Black Belts. Step 101 determines whether the total number of Black Belts has been reached. If not, new potential Black Belts are moved to the training class.

Generally, in a Six Sigma initiative, training occurs at specified times. For example, Black Belts have four weeks of training spread over four months. Black Belts begin working on a project during the training period. Thus, the system moves the Black Belts through the training in a time period representing the first week of the training process. The rest of the training time is incorporated in the time to complete the first project. The system of the present invention determines the timing of Black Belt training for each time period. The Black Belt resources selected at step 101 are moved through the training regime at step 102. As illustrated in FIG. 2, training requires a Master Black Belt input A, since the Master Black Belt is responsible for the training. Even if training is scheduled for a specific time within the system, it may need to be delayed if a Master Black Belt is not available due to other requirements for those resources. The system also allows for reliability factors to adjust for less than optimal performance of some individuals. Some people do not develop as quickly as others. Some lack the aptitude for acquisition of certain skills. The output route of step 102 includes a reliability factor, such as 75%, which is used to determine the number of trained Black Belts that will continue after the completion of the training regime. Black Belts who are not fully trained remain in the training step 102 until after a subsequent training is completed.

At step 103, the trained Black Belts are placed in a pool of resources for working on projects. The Master Black Belt responsible for the training is released back to the pool at B. At step 103, the Black Belts are assigned either as full time or part time workers. A full time Black Belt can typically work on multiple projects at one time. A part time Black Belt only works on a single project. The part time Black Belts are then available to an organization for performing other roles unrelated to working on Six Sigma projects. These differences are accommodated within the system of the present invention by using different project completion times for full time and part time Black Belts. The other roles provided by part time Black Belts are not included within the system, since they are not applicable to the Six Sigma initiative. A parameter is used to determine the number of part time versus full time Black Belts within the system. Projects are generated and assigned by the Champion process, as discussed below.

If a project and a Black Belt are both available, an assignment is made at step 104 and a project commences at step 105. The logic of the assignment step 104 creates the duration, cost and savings elements from use of the Six Sigma initiative. The system uses typical values with various parameters. In particular, according to an embodiment of the invention, a project can be simple or complex. Simple projects take less time, have smaller costs and lower savings. Of course, the system could be adapted to have a larger variety of project complexity parameters. Additionally, the time, cost and savings data can depend upon the level of experience of the Black Belt and whether the Black Belt is full or part time. Of course, many other parameters could also be included in the system for adjusting the time, cost and savings for projects. The system of the present invention includes reliability factors as parameters in the determination of project time. A reliability factor is based upon the resources provided by an organization in connection with the implementation of Six Sigma. For example, training by a more experienced Master Black Belt increases the reliability factor. The same reliability factor is used for all Black Belts in the system. Different parameters can be used to determine the reliability factor.

A project operates according to an acronym DMAICL—Define, Measure, Analyze, Improve, Control and Leverage. At step 105, the Define and Measure parts of the project occur. The Define step seeks to define project goals and determine customer's expectations, both internal and external, for deliverables. The Measurement step determines the current performance of the business process. The time required for these steps depends upon the time determined in the project assignment step 104. Within the system, the DM step 105 represents 30% of the total project time, as determined at step 104. Of course, the time for each step could also be dependent upon a defined distribution rather than just a percentage of the total project time. Other factors can also be used to determine the time required for the project step. For example, the required time may be reduced if a Master Black Belt is available for teaching. In this case, there would need to be an input (not shown) in step 105 from the Master Black Belt pool.

Steps 106 and 107 relate to a tollgate. Tollgates are used to review projects at various stages of the project process. Tollgates allow review of projects to determine whether they should be continued. If the project is unlikely to result in significant savings, it may be terminated before completed. A tollgate typically requires a Master Black Belt for part of the review. Thus, at step 106, the Black Belt's project is placed in a pool for tollgate review with an input A of an available Master Black Belt 10 from the pool 20. If a Master Black Belt is not available, the Black Belt waits until a Master Black Belt is available, which increases the project's cycle time. At step 107, the tollgate review occurs and then the Master Black Belt 10 is released B back to the pool 20. The time required for tollgate review is set as a parameter of the system. The results of the tollgate review are determined at step 108. A certain percentage of projects are estimated to end at this stage. If a project ends, the Black Belt 30 is returned to the project assignment step 104. If the project continues, it moves on to the Project A step 109.

The Analyze step occurs at step 109. This step is used to determine the causes for defects within the business process currently being studied. In the system, this step requires 20% of the total time budget for the project. Of course, as discussed above, other rubrics could be used to determine the time required for this part of the process. Following the Analyze step 109, another tollgate process occurs at steps 110 and 111. Again, the tollgate review has an input A of an available Master Black Belt 10 from the pool 20. The Master Black Belt is released B following the review. The time for the tollgate review depends upon whether or not a Master Black Belt is available for the review. At step 112, the results of the tollgate review are determined. If the project is cancelled, the Black Belt is returned to the project assignment step 104. Otherwise, the project continues to the Improve step 113.

The Improve step is used to make improvements to the business process and to eliminate the causes of defects. The system for the Improve process is similar to that for the other activities in the Black Belt process. The time for this step 113 is 20% of the total project time. Following completion of the Improve step 113, a tollgate review occurs as discussed above. The project is either cancelled, releasing D the Black Belt back to the project assignment step 104, or moves on to the control and leverage step 117.

The control and leverage step monitors the changed process to ensure that defects have been reduced and that the new process is functioning properly. The control and leverage step requires 30% of the total project time. The leverage step also generates a plurality of leverage projects for the Green Belts. In a Six Sigma initiative, leverage substantially increases the savings. Leverage is the application of the solutions implemented in a completed six sigma project to similar businesses processes that were not part of the original project scope. For example, a review of a manufacturing process for a product in one facility can be applied to the manufacturing processes for that product in other facilities. In the system, the number of leveraged projects spawned by an initial project is based upon predetermined distributions.

Following completion of the control step 117, a final review occurs with a Master Black Belt. The project is then completed at step 120 and the Black Belt is released. Following completion of a project, a Black Belt may be reviewed to become a Master Black Belt, at step 121. Only Black Belts who have successfully completed at least two projects are considered to become Master Black Belts in the system. If the desired number of Master Black Belts has not been reached, a certain percentage of Black Belts with sufficient experience are transferred to Master Black Belt training. Of course, other parameters could be used to model the creation of Master Black Belts. At step 123, the new Master Black Belt is trained. Training for Master Black Belts requires three weeks over a three month period. As in the Black Belt training, a reliability factor may be used to determine whether the Black Belt has progressed sufficiently to become a Master Black Belt and move into the coaching, step 124. The new Master Black Belt is added C to the pool 20.

If a Black Belt is not to receive Master Black Belt training another review process occurs. The Black Belt may be removed from the Black Belt pool. Sometimes, personnel are removed from the Six Sigma initiative to provide other roles within an organization. At step 122, Black Belts may be removed from the system. Otherwise, they are returned D to the project assignment pool.

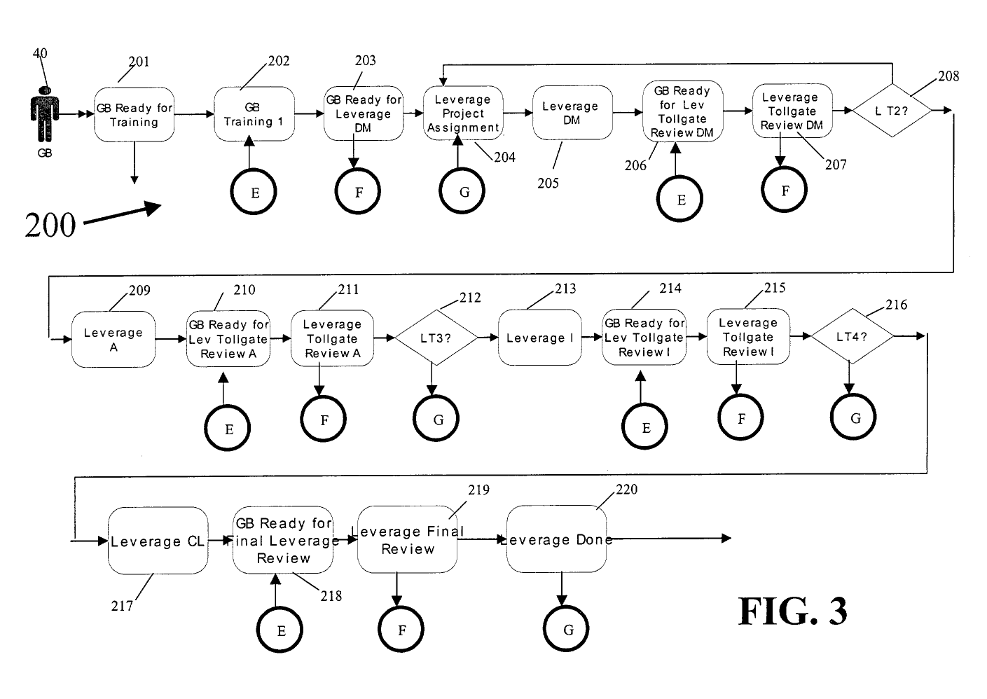

FIG. 3 illustrates the process 200 for Green Belts in the system. Developing Green Belts is a very powerful approach for cascading Six Sigma approaches and techniques throughout an organization. This system assumes that Green Belts receive the same level of training as the Black Belts, hence using the Black Belt curriculum. Changing the training and project completion time parameters can change this assumption, should an organization choose to train Green Belts using a subset of the more comprehensive Black Belt curriculum. The level of skills and knowledge enables Green Belts to serve either lead projects much like Black Belts do, serve as high performing team members on Black Belt project teams, or as valued participants on projects that do not require the Black Belt level of analysis and rigor. Green Belt candidates can be employees at virtually all levels in an organization—frontline employees, engineers, etc. Green Belts are used to leverage the Black Belts for improved performance. The Green Belt process 200 in the system is similar to that for Black Belts, as discussed above.

At step 201, a pool is created of Green Belts ready for training. Green Belts also receive four weeks of training over four months, as provided by the Master Black Belts. The Green Belts remain in the pool at step 201 until training occurs. The training, step 202, requires the input E of a Master Black Belt. As with Black Belt training, a reliability factor or other forms of logic may be incorporated to eliminate a percentage of trainees who still lack the skills to fully function as Green Belts. At step 204, the Green Belts are assigned leveraged projects. As discussed above, leveraged projects are created as a part of completed Black Belt projects. The procedures for leveraged projects are the same as for regular projects. First, the Design and Measure step 205 occurs, followed by a tollgate review 206. The tollgate review step 206 requires an available Master Black Belt, inputted at E and released at F. After the tollgate review, the project continues to the Analyze step 209 or the Green Belt is released for another project assignment. The Analyze step 209, Improve step 213, and Control step 217 are each followed by reviews, as discussed above with respect to the Black Belt process. When a leveraged project is completed, step 220, the Green Belt is released G to the assignment step 204.

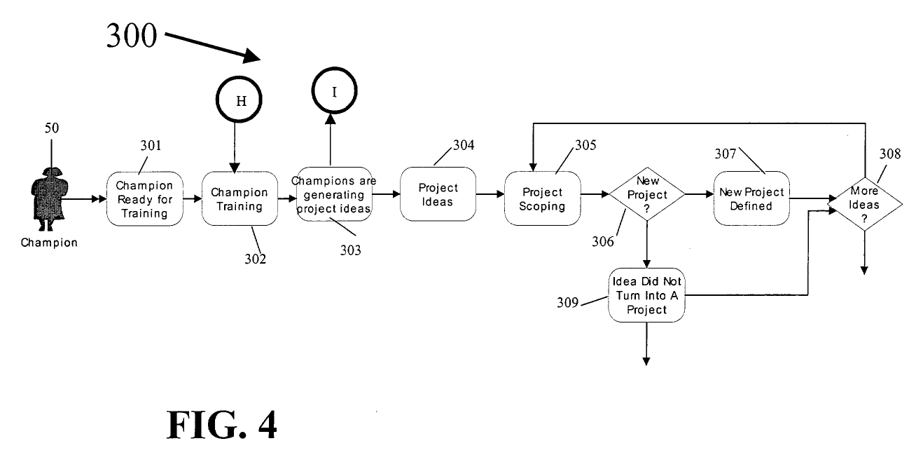

The Champion process 300 is illustrated in FIG. 4. The Champion plays a fundamental role in any successful Six Sigma initiative. The Champion is the individual or group of individuals who are responsible for identifying, prioritizing, and assigning projects that deliver business results consistent with organizational objectives. In addition, Champions monitor project status and success, and ensure that all the necessary resources required for project delivery are made available. As with the Black Belt and Green Belt processes, the first step 301 is the creation of a pool of Champions for training. At appropriate times, training occurs, at step 302, with the input H of a Master Black Belt. In this system, the training parameter for Champions is selectable, with a default value of two days. This training parameter can be set to any amount of time defined by an organization. Once Champions are trained, they are ready to create projects.

The primary role of Champions is the creation of projects for the Black Belts and Green Belts to carry out. Project creation begins with generation of ideas 304. In the system, parameters are created, based upon specified distributions, for each Champion relating to effectiveness. These parameters are used to determine the time to create ideas and the number of ideas created for each Champion. The next step 305 is project scoping. Project scoping is used to convert ideas for process improvement into concrete Six Sigma projects ready to be assigned to Black Belts. The time required to scope each project is dependent upon how the parameters are set for each Champion.

As projects are scoped, additional ideas for projects may be created. At steps 306 and 307, additional project ideas can be created based upon parameters set in the system. Sometimes, during project scoping, the project is rejected. Step 309 allows rejection of projects. Once a project is scoped and not rejected, it is added to the pool of projects available for the Black Belts. Once a project has been fully scoped, or rejected, the Champion is returned, at step 308, to the project scoping step 305 to scope another project. Once all of the ideas have been scoped, as determined at step 308, the Champion exits the system.

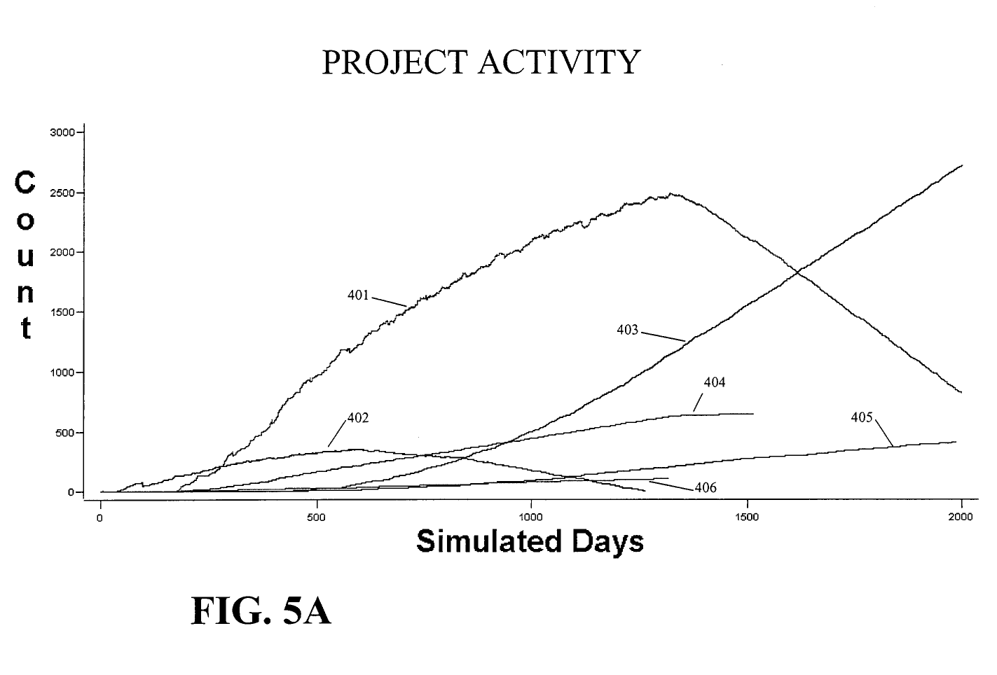

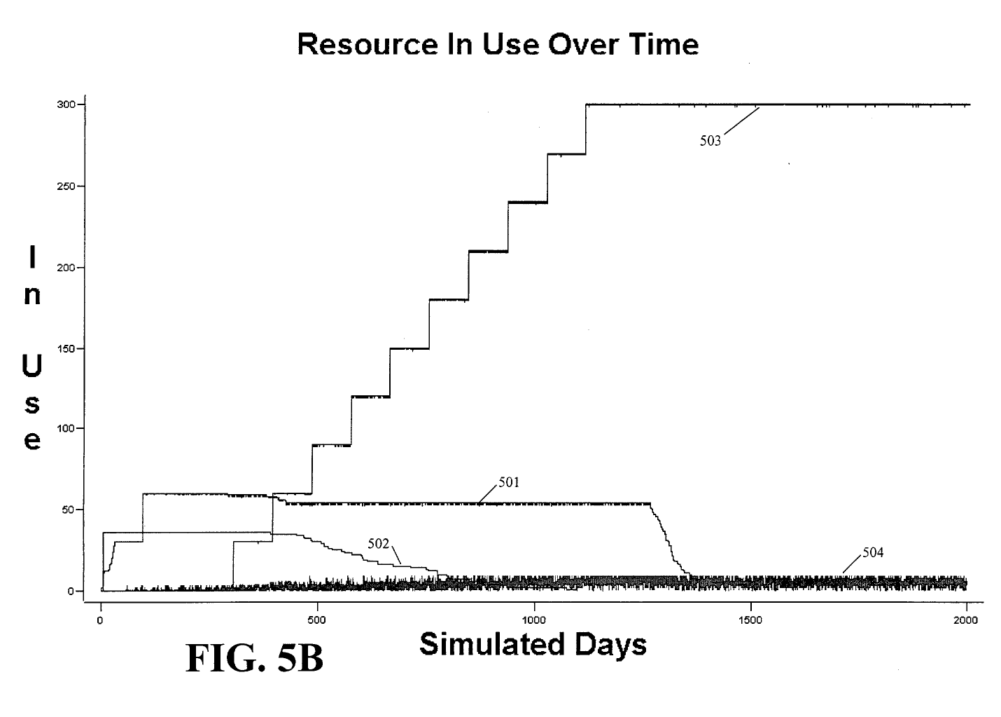

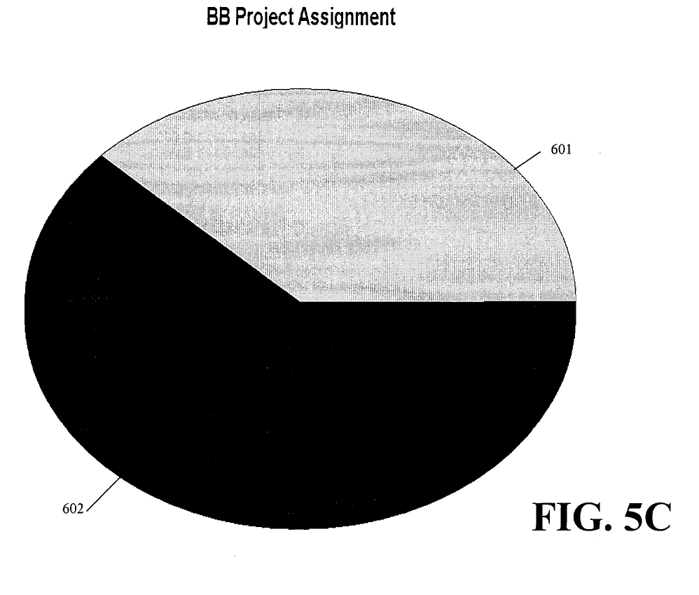

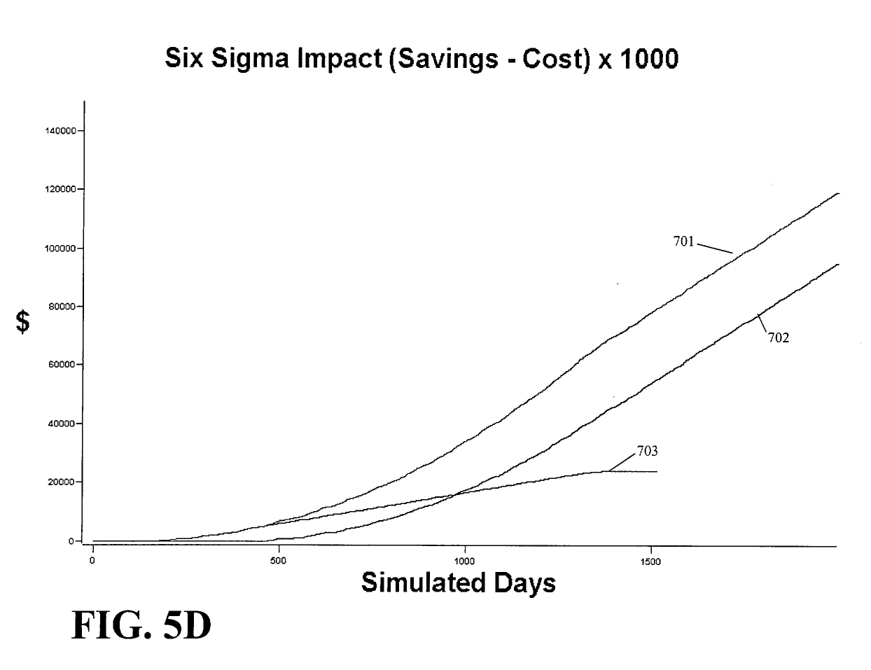

The system of the present invention is designed to analyze the performance and savings in implementing Six Sigma. The system, as discussed above, represents the operation of Six Sigma initiatives. The system operates as a simulation of performance. During operation of the simulation, data is collected to provide analysis. The simulation software operates by moving entities, or people, through the activities (steps) of a Six Sigma initiative. Times are represented as days. Data is collected and stored for each day of the simulation. In particular, the system stores data relating to the numbers of Master Black Belts, Black Belts, Green Belts and Champions, the numbers of projects, the activities of each person in the system, and project costs and savings data. This data provides the basis for analysis of the performance. The data can be manipulated and outputted in various formats. FIGS. 5A-5D represent various outputs of data. Of course, other data or other formats could be used for the outputs.

FIG. 5A represents a graph of Project Activity with respect to days of the simulation. This graph depends upon the stored data with respect to numbers of projects. Graph 401 is the number of Leveraged Projects in the pool to be completed. The projects in the pool increase as Black Belts complete projects and decrease as more Green Belts are trained and available to complete leverage projects. Graph 402 is the Black Belt Project pool. It also illustrates an increase initially and a decrease as more Black Belts are added. Graph 403 is the number of Leveraged Projects completed. Graph 404 is the number of Black Belt Projects completed. Graphs 405 and 406 represent the numbers of Green Belt and Black Belt projects rejected.

FIG. 5B represents resource usage. Graph 501 is the number of Black Belts being used. Graph 502 is the number of champions being used. Graphs 503 and 504 are respectively the numbers of Green Belts and Master Black Belts. FIG. 5C also represents resource utilization. It is a pie graph of available 601 and utilized 602 Black Belts.

FIG. 5D represents savings from implementation of Six Sigma. Graph 701 is the total savings. Graphs 702 and 703 are respectively the savings from Green Belts and Black Belts.

The system of the present invention allows for analysis of the implementation and determines any possible improvements. For example, as illustrated in FIG. 5C, approximately one-third of the time Black Belts need projects. Thus, increasing the number of Champions or limiting the number of Black Belts could obtain better utilization. Alternatively, steps could be taken to improve performance and increase the number of projects created by each Champion. Other scenarios can be run with different parameters to determine the potential effects on savings and utilization. The data outputs can be compared from scenarios to determine improvements.

Various parameters are used in the system to determine times, costs and savings. According to an embodiment of the invention, the parameters are set forth in Table 1.

TABLE 1

| | | 1^{st} Project (Training) | Project Cost | |
|---|---|---|---|---|
| Project Leader | Project Type | Cycle Time (months) | ($000) | Project Savings ($000) |
| BB_FT | Simple | 6 | 15 | 50 |
| | Complex | 8 | 25 | 75 |
| BB_PT | Leverage | 4 | 5 | 40 |
| | Simple | 10 | 15 | 50 |
| | Complex | 18 | 25 | 75 |
| GB | Leverage | 6 | 5 | 40 |
| | Simple | 18 | 15 | 50 |
| | | 2^{nd} Project Cycle Time | Project Cost | |
| Project Leader | Project Type | (months) | ($000) | Project Savings ($000) |
| BB_FT | Simple | 4 | 15 | 50 |
| | Complex | 6 | 25 | 75 |
| BB_PT | Leverage | 2 | 5 | 40 |
| | Simple | 8 | 15 | 50 |
| | Complex | 18 | 25 | 75 |
| GB | Leverage | 4 | 5 | 40 |
| | Simple | 12 | 15 | 50 |
| | | 3^{rd} & subsequent | | |
| | | Project Cycle Times | Project Cost | |
| Project Leader | Project Type | (months) | ($000) | Project Savings ($000) |
| BB_FT | Simple | 2 | 15 | 50 |
| | Complex | 4 | 25 | 75 |
| BB_PT | Leverage | 2 | 5 | 40 |
| | Simple | 8 | 15 | 50 |
| | Complex | 18 | 25 | 75 |
| GB | Leverage | 4 | 5 | 40 |
| | Simple | 12 | 15 | 50 |

Reliability factors are used in the system of the present invention to account for differences in performance of different organizations and individuals. Preferably, these reliability factors would represent actual real-world performance. Different processes can be used to create the reliability factors. According to an embodiment of the invention, the reliability factors for Champions are based upon a rubric from the resources devoted by an organization to implementation of Six Sigma. Table 2 illustrates the factors contributing to the calculation of the reliability factor. For each item in the table, the resources committed by an organization convert to a level of deduction in the reliability factor. For example, if a CEO invests only 2% of his time in the initial kick-off of the implementation, twelve basis points would be deducted. Similarly, creation of a three new Six Sigma positions will result in a 10 basis point deduction. Investing $200,000 in training materials, spending 3% of staff meeting time on Six Sigma, and initially contracting with a Master Black Belt with one year of experience will result in deductions of 10, 12 and 12 basis points, respectively. The total deduction for this example would be 56 basis points. Thus, the reliability factor for the Champions would be 44%. In the system above, the Black Belts were underutilized. The system of the present invention allows an organization to determine the effect of expending more resources to improve the reliability factor of its Champions and better utilize its Black Belts.

TABLE 2

| | | | | | Very | |
|---|---|---|---|---|---|---|
| Champion Training | Metric | Poor | Fair | Good | Good | Excellent |
| Reliability Factor Impact | | | | | | |
| Initial Kick-off by CEO | CEO time invested | 0 | 2% | 4% | 7% | 10% |
| Establish a Program | # New Positions | 0 | 1 | 3 | 5 | 8 |
| Office | Created | | | | | |
| Acquire World-Class | $'s budgeted | $50,000 | $100,000 | $200,000 | $350,000 | $500,000 |
| Training Material | | | | | | |
| Six Sigma Becomes | Staff time invested | 0 | 3% | 6% | 12% | 20% |
| Staff Meeting Item | | | | | | |
| Contract Out Certified | # years experience | 0 | 1 | 2 | 3 | 4 |
| MBB | as MBB | | | | | |
| Impact on Champion | Reliability Factor: | 15 | 12 | 10 | 5 | 0 |
| skill (ability to scope | Bases Points | | | | | |
| projects) | Deducted | | | | | |

The system of the present invention was illustrated with a system for the Six Sigma DMAICL methodology. DMAICL methodologies are used to improve existing business processes. Six Sigma initiatives can also apply to develop new products, services, and processes, as they interact in the market place to capture new sources of revenue to further optimize the value chain. A number of analysis and optimization methodologies are available in future stages of a Six Sigma initiative, such as DMADV for Define, Measure, Analyze, Design and Verify; DFSS for Design For Six Sigma; IDOV for Identify, Design, Optimize, and Verify; etc. The present invention could also be used to model these stages of a Six Sigma initiative. The system would be similar to that illustrated in FIGS. 1-4. However, the specific steps and the parameters applicable to those steps would need to be set for the selected stage of the Six Sigma initiative. The operation of the system would not change. For example, the Black Belt activities would serve as inputs into the DFSS activities since they are necessary skills in order to execute a DFSS project. Thus, the two systems are linked to improve overall decision-making capabilities when implementing a Six Sigma initiative.

In addition to the different stages of a Six Sigma initiative, new roles would be used in these different stages to describe more knowledgeable resources such as Quality Leader, Customer Advocate, etc. Each of these roles is represented as a process in the system. The people in the roles are entities within the system and the activities performed by the people are steps in the process. Similarly, as there will be new stages and new roles, there will also be new types of projects such as a DMADV project, a DFSS project, an IDOV project, a Correlation Study project, etc. These project types are associated with a Six Sigma initiative; however, this invention covers any type of project under business improvement initiatives such as Reengineering, Total Quality Management, Lean Sigma, etc.

According to other embodiments of the invention, the system may include other pieces of functionality. One piece of functionality the system may include is a Black Belt or Green Belt's ability to handle multiple projects at one time. For example, a Black will begin a new Six Sigma project, which is in the DM Tollgate, while another project is still underway and is in the CL Tollgate. A second piece of functionality the system may include is the interaction between entities to the ability to measure how these interactions improve performance. For example, an Master Black Belt available to review a Black Belt's project with a Champion present will improve the project's cycle time and overall return on investment. The more frequent the interaction, the better the results. Another example is to measure a Champion's ability to scope projects when that Champion has not completed any Champion training but interacts with a very knowledgeable Master Black Belt. The measure of these interactions will yield a certain level of knowledge transfer within the knowledge management system. A third piece of functionality is the ability to track the quality of a Six Sigma project. For example, attributes will be assigned to the Six Sigma project to determine its completeness and accuracy based on completion of tasks by the Black Belt and Green Belt, which can be varied using system parameters and reliability factors. The Green Belt process may be expanded to gage the performance of Green Belts in closing their projects with positive return on investment. Using a blend of reliability factors, cycle time, and action logic, the system can help the user understand the efficiency of Green Belts, the training and support, and the impact a Green Belt program has on the Six Sigma initiative.

By adjusting the parameters in the system, the present invention may also be used to analyze the actual performance of a Six Sigma implementation and determine areas of improvement. The reliability factors can be obtained from empirical information on an organization's implementation. Similarly, information on times, costs and savings could be similarly collected and used in the system. In this manner, operation of a Six Sigma initiative within an organization can be reviewed and adjustments made as necessary.

The invention is not limited to the described system or model. A system can be developed using other types of software and modeling approaches. Examples include, and not limited to, Deterministic models such as Microsoft Excel, Static models such as Crystal Ball, Discrete-Event Simulation models such as ProcessModel, Linear/Non-Linear Optimization models such as dashoptimization, and System Dynamic models such as Vensim. However, with any modeling approach or software, the system of the present invention moves resources (people or entities) move through activities. As the resources move through the activities, their knowledge increases, and their ability to scope, execute, and/or support Six Sigma projects improves over time.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A system for simulating implementation of a Six Sigma initiative, comprising:
a plurality of processes, each process including a corresponding plurality of activities, wherein each process corresponds to a role in the Six Sigma initiative;
a plurality of entities corresponding to each of the plurality of processes; and
means for moving the entities through the plurality of activities in accordance with the corresponding process.
